(19) United States
(12) Patent Application Publication
(10) Pub. No.: US 2016/0205496 A1
(43) Pub. Date: Jul. 14, 2016

(54) BLUETOOTH LOW ENERGY (BLE) TRANSMISSION AND RECEPTION DEVICES IN A COMMUNICATION SYSTEM AND METHODS THEREOF

(71) Applicant: Wistron Corp., New Taipei City (TW)

(72) Inventor: Chih-An SU, New Taipei City (TW)

(21) Appl. No.: 14/695,860

(22) Filed: Apr. 24, 2015

(30) Foreign Application Priority Data
Jan. 8, 2015 (TW) 104100491

(51) Int. Cl. H04W 4/00; H04W 4/06

(52) U.S. Cl. CPC H04W 4/008; H04W 4/06

(57) ABSTRACT

Bluetooth Low Energy (BLE) transmission and reception devices in a communication system and methods thereof are disclosed. The method of transmitting time via Bluetooth Low Energy is adopted by a BLE transmission device, and includes: reading, by a controller, local time information of the BLE transmission device; and transmitting, by a BLE transmitter, the local time information to one or more receivers.

### CROSS REFERENCE TO RELATED APPLICATIONS

This Application claims priority of Taiwan Patent Application No. 104100491, filed on Jan 8, 2015, the entirety of which is incorporated by reference herein.

### BACKGROUND

1. Field

The present disclosure relates to communication system, and in particular, to Bluetooth Low Energy (BLE) transmission and reception devices in a communication system and methods thereof.

2. Description of the Related Art

Bluetooth Low Energy (BLE) is a short-range, low-power wireless communication technology. A BLE signal may reach as far as 100 meters. iBeacon is a specification defined based on the BLE technology, providing positioning and other applications in an indoor environment.

The embodiments of the invention provide implementations for transmitting time information in a BLE communication system.

### BRIEF SUMMARY OF THE DISCLOSURE

A detailed description is given in the following embodiments with reference to the accompanying drawings.

An embodiment of a method of transmitting current time via a Bluetooth Low

Energy (BLE) technology is disclosed, adopted by a BLE transmission device, comprising: reading, by a controller, local time information of the BLE transmission device; and transmitting, by a BLE transmitter, the local time information to one or more receivers.

Another embodiment of a method of receiving time via a Bluetooth Low Energy (BLE) technology is provided, adopted by a BLE reception device, comprising: receiving, by a BLE receiver, remote time information at a BLE transmission device; and configuring, by a controller, local time of the BLE reception device according to the remote time information of a BLE transmission device.

Another embodiment of a Bluetooth Low Energy (BLE) transmission device is revealed, comprising a controller and a BLE transmitter. The controller is configured to read local time information of the BLE transmission device. The BLE transmitter is configured to transmit the local time information to one or more receivers.

Another embodiment of a Bluetooth Low Energy (BLE) reception device is described, comprising a controller and a BLE receiver. The BLE receiver is configured to receive remote time information of a BLE transmission device. The controller is configured to configure local time of the BLE reception device according to the remote time information of a BLE transmission device.

### BRIEF DESCRIPTION OF THE DRAWINGS

The present disclosure can be more fully understood by reading the subsequent detailed description and examples with references made to the accompanying drawings, wherein:

FIG. 1 is a schematic diagram of a BLE system 1 according to an embodiment of the invention.

FIGS. 2A, 2B, and 2C show schematics of data packet formats adopted in the advertisement communication channel according to embodiments of the invention.

FIGS. 3A through 3D illustrate embodiments of the time information in the PDU transmitted on the advertisement communication channel in the invention.

FIG. 4 is a block diagram of a BLE transmission device 4 according to an embodiment of the invention.

FIG. 5 is a block diagram of a BLE reception device 5 according to an embodiment of the invention.

FIG. 6 is a flowchart of a BLE transmission method 6 according to an embodiment of the invention.

FIG. 7 is a flowchart of a BLE reception method 7 according to an embodiment of the invention.

FIG. 8 is a flowchart of a BLE transmission method 8 according to another embodiment of the invention.

FIG. 9 is a flowchart of a BLE reception method 9 according to another embodiment of the invention.

### DETAILED DESCRIPTION OF THE DISCLOSURE

The following description is of the best-contemplated mode of carrying out the disclosure. This description is made for the purpose of illustrating the general principles of the disclosure and should not be taken in a limiting sense. The scope of the disclosure is best determined by reference to the appended claims.

The term “Bluetooth Low Energy (BLE) transmission and reception devices” described herein may refer to a smart phone, a notebook computer, a tablet computer, an iBeacon device, or a wireless communication device supporting BLE specification.

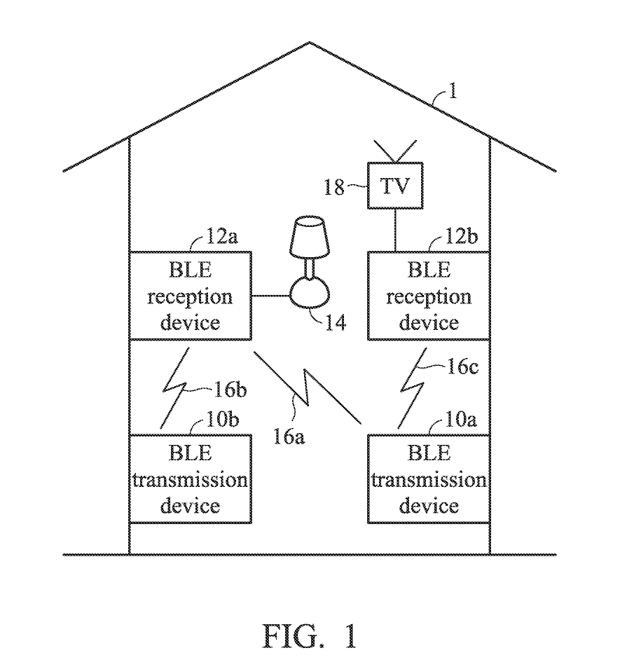

FIG. 1 is a schematic diagram of a BLE system 1 according to an embodiment of the invention, adopted in various indoor applications such as an automated home, indoor navigation, a retail application, or a medical application. The BLE system 1 illustrates an embodiment for the automated home application, including a BLE transmission devices 10a, 10b, BLE reception devices 12a, 12b, a controlled lighting device 14, and a controlled television (TV) 18. As shown in FIG. 1, the BLE transmission devices 10a, 10b and the BLE reception devices 12a, 12b communicate to each other via BLE signals 16a, b, c to control the operations of the controlled lighting device 14 and the controlled TV 18. The BLE transmission devices 10a, 10b and the BLE reception devices 12a, 12b may be fixed or mobile equipment. The BLE reception devices 12a, 12b may or may not possess a time function. Before the BLE transmission devices 10a, 10b and the BLE reception devices 12a, 12b establish a connection, the BLE transmission devices 10a, 10b can transmit time information to one or more BLE reception devices 12a, 12b, e.g., broadcasting the time information with a fixed period. The BLE reception devices 12a, 12b may receive the time information when detecting the BLE transmission devices 10a, 10b, and perform an associated operation triggered by the received time information. For example, the BLE reception devices 12a may control the controlled lighting device 14 to be turned on during a certain predefined period of time and turned off during the rest of the time, the BLE reception device 12b may control the controlled TV 18 to be turned on during a certain predefined period of time and turned off during the rest of the time.

The BLE communication between the BLE transmission devices 10a, 10b and the BLE reception devices 12a, 12b may operate in two primary modes, namely, an advertising mode and a connecting mode. The advertising mode is a unidirectional discovery mechanism. During the advertising mode, the BLE transmission devices 10a, 10b may broadcast device information of the BLE transmission devices 10a, 10b via an adverting channel in a broadcast period ranging from 10 to 20 milliseconds. The shorter the broadcast period is, the faster the BLE transmission devices 10a, 10b may discover the BLE reception devices 12a, 12b, at the expense of a shorter battery life of the BLE transmission devices 10a, 10b. Once the BLE transmission devices 10a, 10b are discovered, it may establish a connection with the BLE reception devices 12a, 12b and enter the connecting mode. In the connecting mode, the BLE reception devices 12a, 12b may read the service type provided by the BLE transmission devices 10a, 10b and provide a certain figure according to the property of each service, which may be read, written, or both. For instance, a smart thermostat may acquire reading for current temperature or humidity (properties of the service) and other service properties to configure a temperature required by the service.

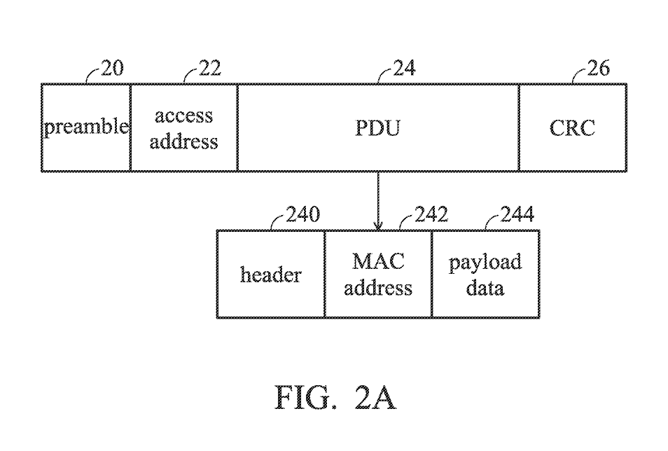

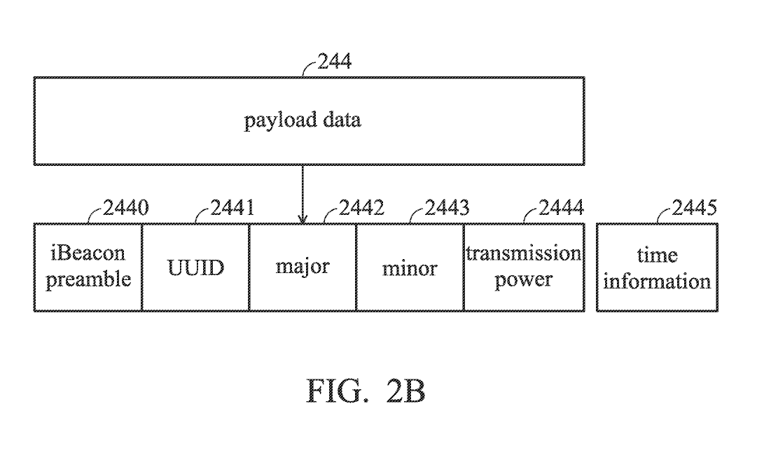

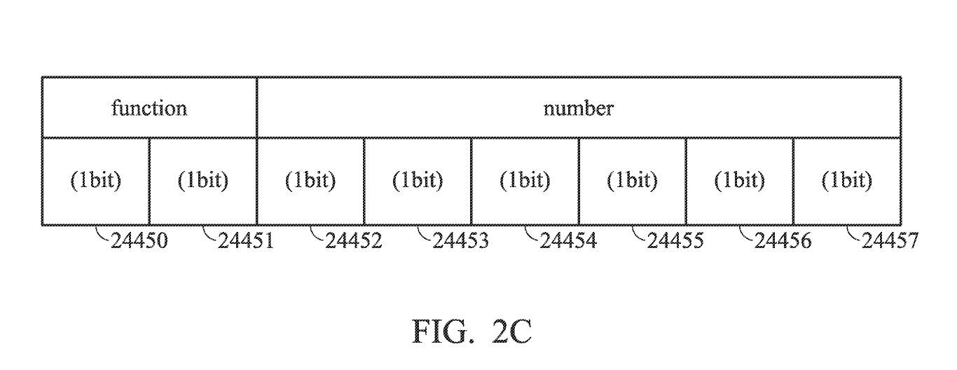

FIGS. 2A, 2B, and 2B show schematics of data packet formats adopted in the advertisement communication channel according to embodiments of the invention. The device information of the BLE transmission devices 10a, 10b includes an advertising packet broadcast via the advertisement communication channel. BLE specification defines the advertising packet containing up to 47 bytes, as indicated in FIG. 2A. The advertising packet contains preamble data 20 with 1 byte, an access address 22 with 4 bytes, a Packet Data Unit (PDU) 24 in the advertisement communication channel with 2 to 39 bytes, and a Cyclic Redundancy Check (CRC) code 26 with 3 byes. The access address is Ox8E89BED6 for the advertisement communication channel. The PDU 24 in the advertisement communication channel includes a header 240 (2 bytes), a MAC address 242 (6 bytes), and valid data (up to 31 bytes) 244. The header 240 contains information such as the valid payload, the data type, the data size, and the connectivity supportability. The MAC address 242 is the MAC address of the BLE transmission devices 10a, 10b. FIG. 2B shows a format for the valid payload 244 adopted in iBeacon according to an embodiment of the invention, including iBeacon preamble data 2440, a proximity Universal Unique Identifier (UUID) 2441, a major 2442, a minor 2443, a transmission power 2444, and time information 2445. The iBeacon preamble data 2440 includes an advertising text string with fixed length of 9 bytes, e.g., 02 01 06 lA FF 4C 00 02 15. The proximity UUID 2441 is a 16-byte identifier used for identifying the BLE transmission devices 10a, 10b, e.g., B9 40 7F 30 F5 F8 46 6E AF F9 25 55 6B 57 FE 6D. The major 2442 and the minor 2443 are 2-byte serial numbers for identifying an iBeacon group and an iBeacon entity, respectively, and may be, e.g., 00 49 and 00 0A, respectively. The transmission power 2444 includes the transmission power measured from a nearby iBeacon device in 1 byte, and may be, e.g., C5. The time information 2445 is current time information of the BLE transmission devices 10a, 10b, including a local time at the BLE transmission devices 10a, 10b and a transmission period (broadcast period) for issuing the advertising packets. The time information 2445 includes two regions, and has a data size of 1 byte, or 8 bits, wherein the first 2 bits are defined as a functional region, the last 6 bits are defined as a number region, as indicated in FIG. 2C. The functional region indicates the meaning of the time information in the subsequent number region, as shown in table 1 as following, the function region may represent 4 types of time information:

TABLE 1

| Function | Time Information |
|---|---|
| 00 | Represent a transmission period (broadcast period) of |
| | the BLE transmission device, the subsequent number region |
| | represents an interval in seconds (represents 1 second |
| | when the number is less than 1) |
| 01 | Represent a time of the BLE transmission device in seconds, |
| | the subsequent number region represents |
| | a number in seconds (0~59) |
| 10 | Represent a time of the BLE transmission device in minutes, |
| | the subsequent number region represents |
| | a number in minutes (0~59) |
| 11 | Represent a time of the BLE transmission device in hours, |
| | the subsequent number region represents |
| | a number in hours (0~24) |

The BLE transmission devices 10a, 10b may broadcast the time information of the 4 types of time information sequentially and periodically on the advertisement communication channel. When the BLE reception devices 12a, 12b detect an advertising packet from the advertisement communication channel they may also receive the time information, and perform an associated task triggered by the received time information.

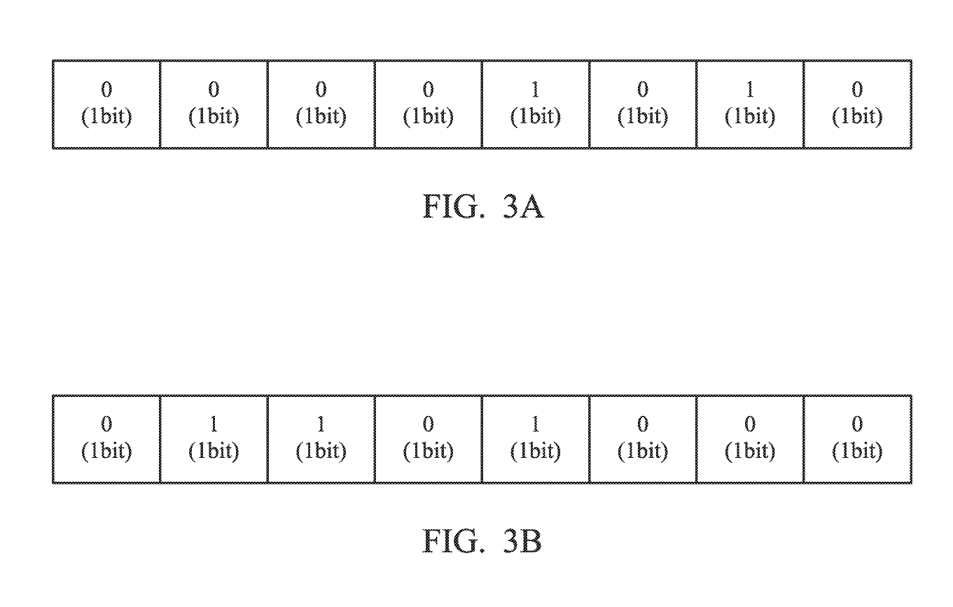

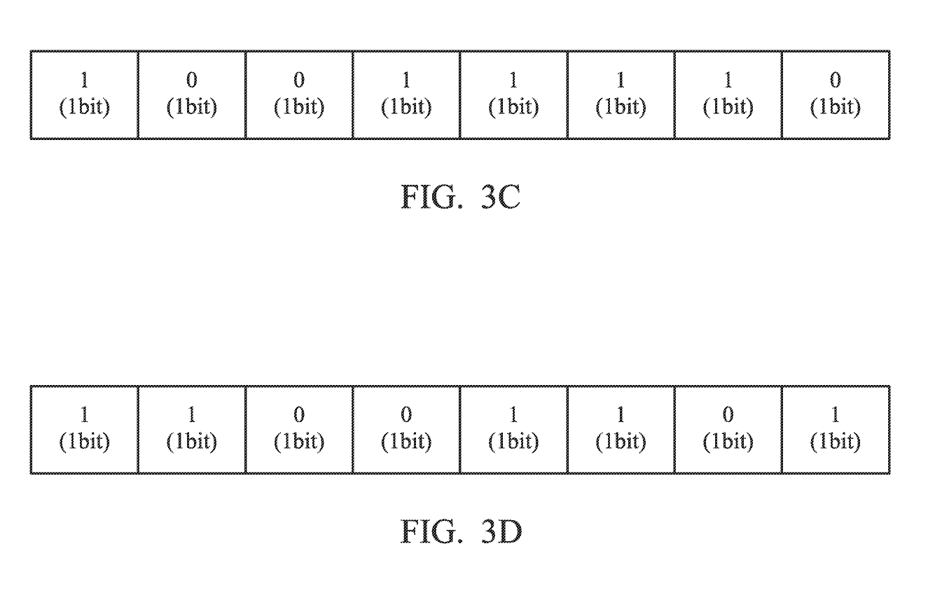

FIGS. 3A through 3D illustrate embodiments of the time information in the PDU transmitted on the advertisement communication channel in the invention. As shown in FIG. 3A, the BLE transmission devices 10a, 10b may broadcast advertising packets on the advertisement communication channel, on which the PDU includes time information of b′00001010, wherein the 2-bit function region is b′00, and the subsequent 6-bit number region is b′001010, indicating that the advertising packet contains the transmission period of the BLE transmission devices 10a, 10b, and the transmission period is 10 seconds, representing that the BLE transmission devices 10a, 10b will transmit the advertising packet which includes the time information on the advertisement communication channel once every 10 seconds.

As shown in FIG. 3B, the BLE transmission devices 10a, 10b may broadcast advertising packets on the advertisement communication channel, on which the PDU includes time information of b′01101000, wherein the 2-bit function region is b′01, and the subsequent 6-bit number region is b′101000, indicating that the advertising packet contains a time of the BLE transmission devices 10a, 10b in seconds, and the time in seconds is 40 seconds.

As shown in FIG. 3C, the BLE transmission devices 10a, 10b may broadcast advertising packets on the advertisement communication channel, on which the PDU includes time information of b′10011110, wherein the 2-bit function region is b′10, and the subsequent 6-bit number region is b′011110, indicating that the advertising packet contains a time of the BLE transmission devices 10a, 10b in minutes, and the time in minutes is 30 minutes.

As shown in FIG. 3D, the BLE transmission devices 10a, 10b may broadcast advertising packets on the advertisement communication channel, on which the PDU includes time information of b′11001101, wherein the 2-bit function region is b′11, and the subsequent 6-bit number region is b′001101, indicating that the advertising packet contains a time of the BLE transmission devices 10a, 10b in hours, and the time in hours is 13 hours.

The advertising packets are broadcast in a round-robin manner in 4 periods, and the BLE reception devices 12a, 12b only need to acquire 4 receptions to obtain the time information provided by an iBeacon device for further processing.

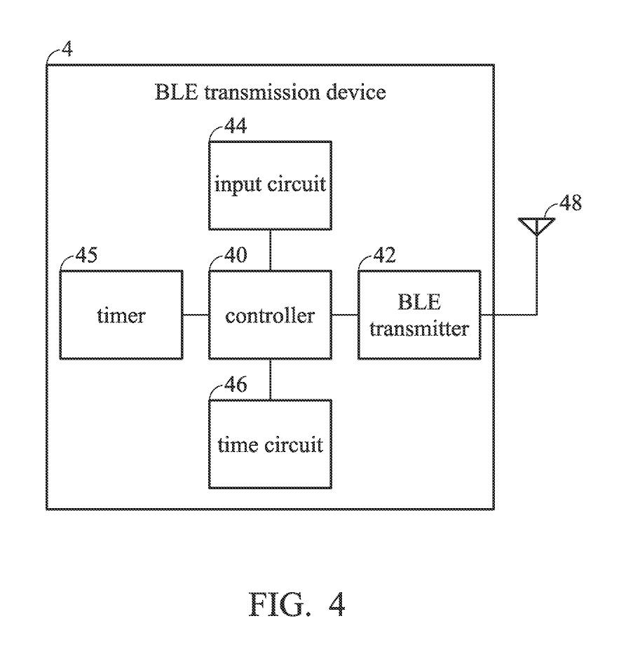

FIG. 4 is a block diagram of a BLE transmission device 4 according to an embodiment of the invention, serving as the BLE transmission devices 10a, 10b in FIG. 1. The BLE transmission device 4 includes a controller 40, a BLE transmitter 42, an input circuit 44, a timer 45, a time circuit 46 and an antenna 48.

The timer 45 may calculate whether the broadcast period of the BLE transmission device 4 has expired. The time circuit 46 generates the current time in seconds, minutes, hours, and other time information such as the current year, month, date of the BLE transmission device. The input circuit 44 includes an input interface receiving a user input, and configures the broadcast period of the timer 45 based on the user input or other input. If the user does not configure the broadcast period manually, the input circuit 44 may set a predefined broadcast period as the broadcast period of the timer 45.

When the broadcast period expires, the timer 45 may send an expiration signal to the controller 40, which may read the current time in seconds, minutes, hours to be transmitted from the time circuit 46 or the broadcast period from a data register (not shown), and broadcast the read time information along with other BLE data, such as the iBeacon data in FIG. 2B, on the advertisement communication channel via the transmitter 42 and the antenna 48.

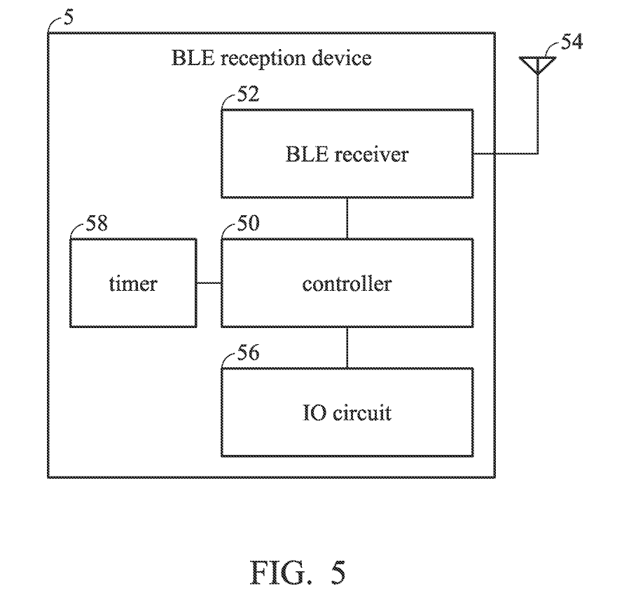

FIG. 5 is a block diagram of a BLE reception device 5 according to an embodiment of the invention, serving as the BLE reception devices 12a, 12b in FIG. 1. The BLE reception device 5 includes a controller 50, a BLE receiver 52, an antenna 54, an Input/output (IO) circuit 56, and a timer 58.

The timer 58 may calculate whether the broadcast period of the BLE reception device 5 has expired. The 10 circuit 56 is coupled to a controlled device (not shown) to control the operations thereof, such as the turning-on and turning-off of a lighting device, the turning-on and turning-off of an alarm device, and the operations of an entertainment device and a home appliance. When the broadcast period expires, the timer 58 may send an expiration signal to the controller 50, which in turn may scan and receive the advertising packets of the BLE transmission device from the advertisement communication channel via the receiver 52 and the antenna 54, and retrieve remote time information of the BLE transmission device from the advertising packets. The remote time information includes the current time in seconds, minutes, and hours of the BLE transmission device or the broadcast period for transmitting the advertising packets. The controller 50 may store the remote time information retrieved from the advertising packets, or configure the remote time information as the local time of the BLE reception device. Moreover, the controller 50 may further configure the broadcast period by the retrieved broadcast period. While the BLE reception device 5 has not yet received the broadcast period from an advertising packet, the controller 50 may configure a predetermined broadcast period as the broadcast period of the timer 58, e.g., 20 ms.

After the time information is received, the controller 50 may determine whether any trigger conditions are met based on the remote time information. For example, determining whether the current local time falls into a predefined time interval. When a trigger condition is met, the controller 50 may perform a triggered operation, such as turning the power supply on or off.

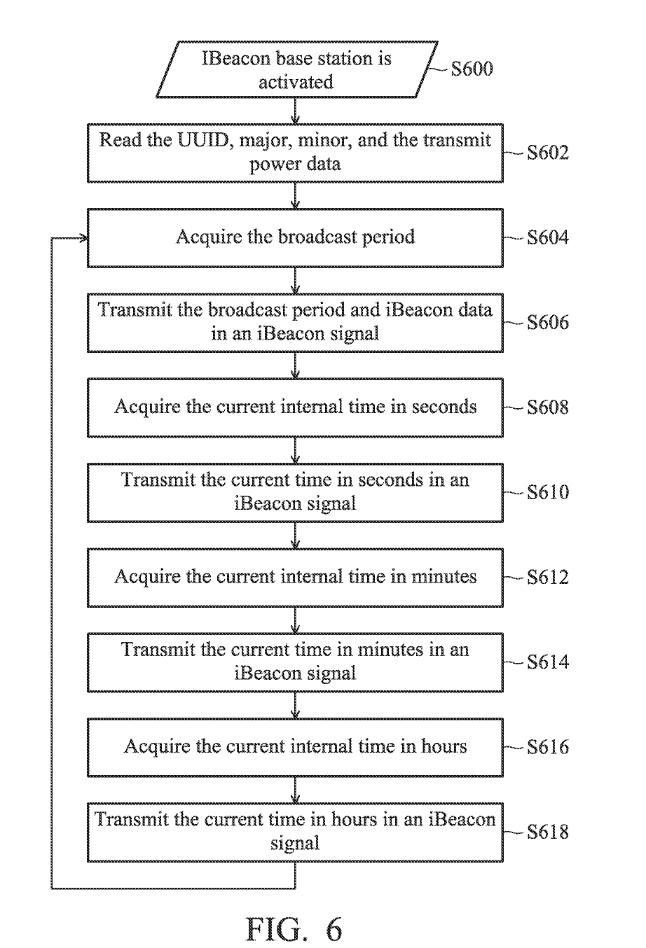

FIG. 6 is a flowchart of a BLE transmission method 6 according to an embodiment of the invention, adopted by an iBeacon base station. The BLE transmission method 6 starts upon the iBeacon base station being powered on (S600).

First, the iBeacon base station may read the UUID, major, minor, and the transmit power data from an internal data storage device (S602) and acquire the broadcast period (S604), which is stored in an internal data storage device in the iBeacon base station, and may be configured by a user through an input interface of the iBeacon base station, or may be a predefined value such as 1 second. The input interface may be implemented by the iBeacon base station or a server connected to the iBeacon base station.

Next, the iBeacon base station may transmit the broadcast period and iBeacon data in an iBeacon signal to one or more receivers (S606). In certain embodiments the iBeacon base station may broadcast the time information according to the broadcast period. For example, when the broadcast period is 1 second, the iBeacon base station may send out an iBeacon signal on the advertisement communication channel each second. Each period contains 4 iBeacon signals, wherein the first iBeacon signal includes the UUID, major, minor, and the transmit power data, and the broadcast period (1 second).

When the iBeacon base station determines that the next broadcast period is going to expire or has expired, it will check the current internal time in seconds (S608), e.g., the current time in seconds may be 10 seconds. After the broadcast period has expired, the iBeacon base station may transmit a second iBeacon signal containing the current time in seconds and iBeacon data (S610), wherein the iBeacon data includes the UUID, major, minor, and the transmit power data.

Next, when the iBeacon base station determines that the next broadcast period is going to expire or has expired, it will check the current internal time in minutes (S612), e.g., the current time in minutes may be 20 minutes. After the broadcast period has expired, the iBeacon base station may transmit a third iBeacon signal containing the current time in minutes and iBeacon data (S614).

Finally, when the iBeacon base station determines that the next broadcast period is going to expire or has expired, it will check the current internal time in hours (S616), e.g., the current time in hours may be 18 hours. After the broadcast period has expired, the iBeacon base station may transmit a fourth iBeacon signal containing the current time in hours and iBeacon data (S618).

The iBeacon base station may perform Step S604 through S618 repeatedly, transmitting the time information which include the broadcast period, current time in seconds, minutes, and hours every 4-iBeacond signal cycle. In certain embodiments, the iBeacon base station may transmit the time information in an order different from what defines in Step S604 through S618.

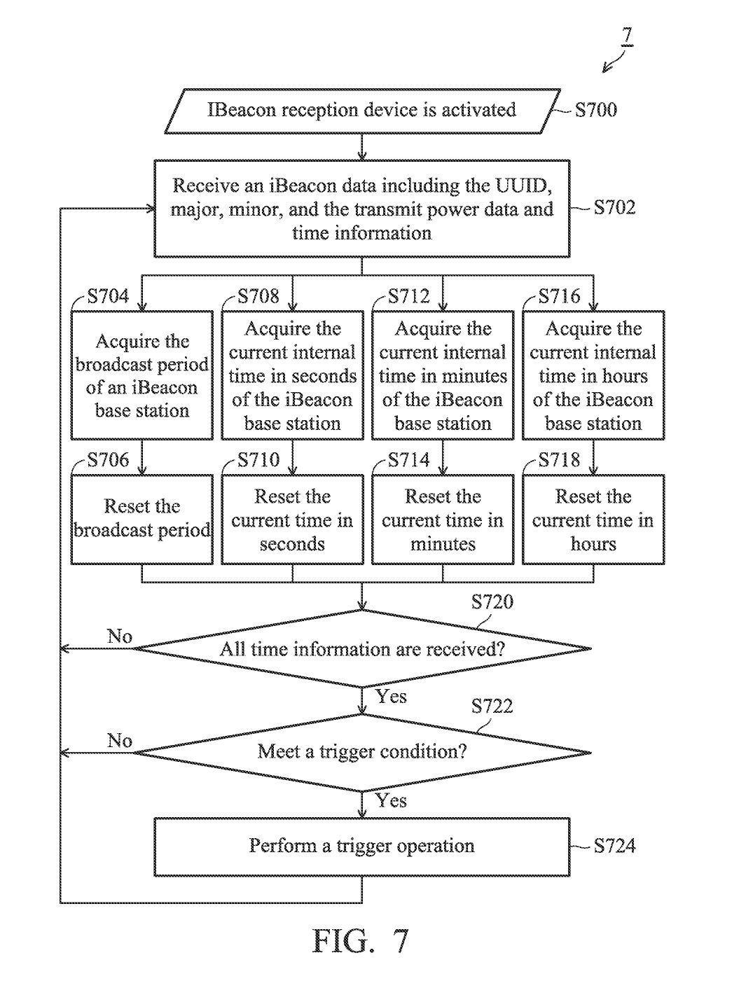

FIG. 7 is a flowchart of a BLE reception method 7 according to an embodiment of the invention, adopted by an iBeacon reception device. The BLE reception method 7 starts upon the iBeacon reception device being powered on (S700). The iBeacon reception device may be a smart home appliance.

First, the iBeacon reception device may receive an iBeacon signal regularly, which includes iBeacon data such as the UUID, the major, the minor, the transmit power data, and the time information (S702), which may be the broadcast period, and the current time in seconds, minutes, or hours. Immediately after being powered-on, the iBeacon reception device is not yet aware of the broadcast period of the iBeacon base station, and thus a predefined broadcast period may be used to monitor the iBeacon signals on the advertisement communication channel.

After receiving iBeacon signals, the iBeacon reception device may determine that the time information therein is one of the broadcast period, or the current time in seconds, minutes, and hours of the iBeacon base station. When it is determined that the time information is the broadcast period of the iBeacon base station (S704), the iBeacon reception device may reset the monitoring broadcast period according to the broadcast period of the iBeacon base station (S706). When it is determined that the time information is the current time in seconds of the iBeacon base station (S708), the iBeacon reception device may reset the local current time in seconds as the current time in seconds of the iBeacon base station (S710). When it is determined that the time information is the current time in minutes of the iBeacon base station (S712), the iBeacon reception device may reset the local current time in minutes as the current time in minutes of the iBeacon base station (S714). When it is determined that the time information is the current time in hours of the iBeacon base station (S716), the iBeacon reception device may reset the local current time in hours as the current time in hours of the iBeacon base station (S718).

Since the iBeacon base station transmits the 4 time information by a 4-iBeacon signal cycle, after collecting all 4 iBeacon signals, the iBeacon reception device may determine whether all time information have been collected (S720). If not, the BLE reception method 7 will return to Step S702 for the iBeacon reception device to continue collecting the iBeacon signals. If all iBeacon signals are collected, then the BLE reception method 7 determines whether the trigger condition is met based on the configured local current time (S722). If the trigger condition is not met, the BLE reception method 7 will return to Step S702 for the iBeacon reception device to continue collecting the iBeacon signals. If the trigger condition is met, the BLE reception method 7 may perform a corresponding trigger operation (S724), e.g., turning a lighting device on or off

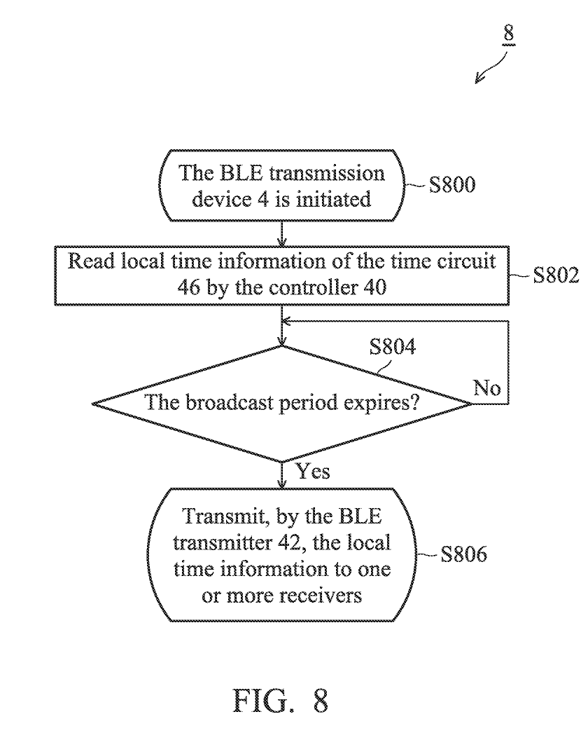

FIG. 8 is a flowchart of a BLE transmission method 8 according to an embodiment of the invention, adopted by the BLE transmission device 4 in FIG. 4. The BLE transmission method 8 starts upon the BLE transmission device 4 being powered on (S800).

First, the controller 40 of the BLE transmission device 4 may read the UUID, the major, the minor, the transmit power data and the local time information (S802). The local time information may be the broadcast period, or the current time in seconds, minutes, or hours. The broadcast period may be configured by a user, the current time in seconds, minutes, and hours may be timed by the internal time circuit 46.

Moreover, the timer 45 may count the broadcast period. When the broadcast period expires, an expiration signal is transmitted to the controller 40 to inform the controller 40 of the expiry of the broadcast period. The controller 40 may determine whether the broadcast period is expired (S804). When the broadcast period is not expired the BLE transmission method 8 will go back to Step S804, waiting for the expiry of the broadcast period; whereas the broadcast period is expired, the BLE transmitter 42 may broadcast the local time information on the advertisement communication channel (S806). The local time information is transmitted along with the UUID, the major, the minor, the transmit power data in an advertising packet to a neighboring BLE reception device.

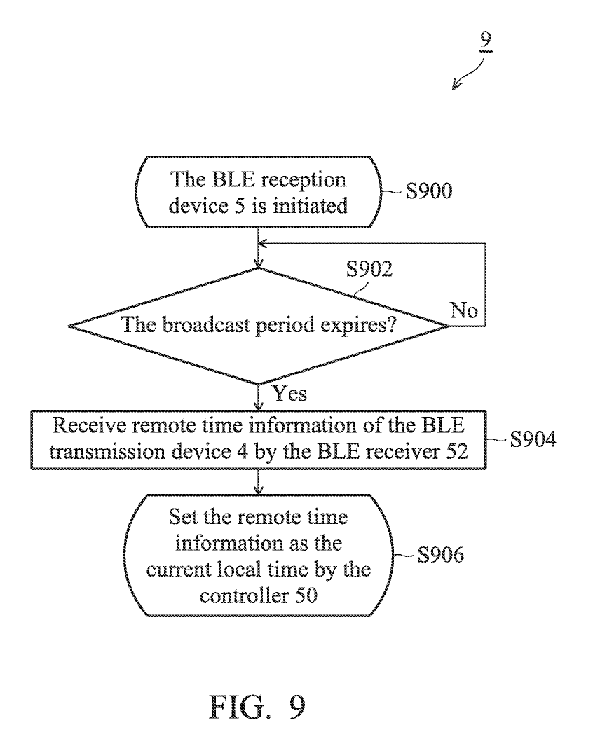

FIG. 9 is a flowchart of a BLE reception method 9 according to an embodiment of the invention, adopted by a BLE reception device 5. The BLE reception method 9 starts upon the BLE reception device 5 being powered on (S900).

The timer 58 may count a reception period. When the reception period expires, an expiration signal is transmitted to the controller 50 to inform the controller 50 of the expiry of the reception period. The reception period may be predefined. The controller 50 may determine whether the reception period has expired (S902). When the reception period has not expired, the BLE reception method 9 will go back to Step S902, waiting for the expiry of the reception period; whereas when the reception period has expired, the BLE receiver 52 may receive a BLE advertising packet which includes the remote time information on the advertisement communication channel (S904). The remote time information includes the broadcast period, and the time in seconds, minutes, and hours.

If the received BLE advertising packet includes the time in seconds, minutes, or hours, the controller 50 may set the received time in seconds, minutes, or hours as the local current time (S906). If the received BLE advertising packet includes the broadcast period, the controller 50 may then set the received broadcast period as the reception period for the timer 58.

After the current time is set, the controller 50 may further determine whether a trigger condition is met according to the current time, and perform a corresponding trigger operation upon meeting the trigger condition.

The BLE transmission and reception methods in FIGS. 4 through 9 transmit time information in a advertising packet from a BLE transmission device to a BLE reception device, thus the BLE reception device may know the current time without the need for establishing a connection with the BLE transmission device or an internal clock, and may perform a triggered operation based on the current time.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The operations and functions of the various logical blocks, modules, and circuits described herein may be implemented in circuit hardware or embedded software codes that can be accessed and executed by a processor.

While the disclosure has been described by way of example and in terms of the preferred embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of transmitting current time via a Bluetooth Low Energy (BLE) technology, adopted by a BLE transmission device, comprising:
reading, by a controller, local time information of the BLE transmission device; and
transmitting, by a BLE transmitter, the local time information to one or more receivers.

2. The method of claim 1, wherein the step of transmitting the local time information is performed by periodic broadcasting.

3. The method of claim 2, further comprising:
periodically broadcasting , by the BLE transmitter, a broadcast period.

4. The method of claim 3, further comprising:
receiving, by an input circuit, a configuration of the broadcast period.

5. The method of claim 1, wherein the BLE transmitter transmits the local time information in an advertising Packet Data Unit (PDU) via an advertisement communication channel.

6. The method of claim 1, wherein the local time information includes one of current time in seconds, minutes and hours at the BLE device.

7. A method of receiving time via a Bluetooth Low Energy (BLE) technology, adopted by a BLE reception device, comprising:
receiving, by a BLE receiver, remote time information of a BLE transmission
configuring, by a controller, local time of the BLE reception device according to the remote time information of a BLE transmission device.

8. The method of claim 7, further comprising:
receiving, by the BLE receiver, a broadcast period; and
configuring the BLE receiver according to the broadcast period to receive the remote time information of the BLE transmission device.

9. The method of claim 7, wherein the BLE receiver receives the remote time information in an advertising Packet Data Unit (PDU) via an advertisement communication channel.

10. The method of claim 7, wherein the remote time information includes one of current time in seconds, minutes and hours at the BLE device.

11. The method of claim 7, further comprising:
determining, by the controller, whether a trigger condition is met based on the local time of the BLE reception device; and
when the trigger condition is met, performing, by the controller, a trigger operation.

12. A Bluetooth Low Energy (BLE) transmission device, comprising:
a controller, configured to read local time information of the BLE transmission device; and
a BLE transmitter, configured to transmit the local time information to one or more receivers.

13. The BLE transmission device of claim 12, wherein the BLE transmitter is configured to broadcast the local time information periodically.

14. The BLE transmission device of claim 13, wherein the BLE transmitter is configured to periodically broadcast a broadcast period.

15. The BLE transmission device of claim 14, further comprising:
an input circuit, configured to receive a configuration of the broadcast period.

16. The BLE transmission device of claim 12, wherein the BLE transmitter is configured to transmit the local time information in an advertising Packet Data Unit (PDU) via an advertisement communication channel.

17. The BLE transmission device of claim 12, wherein the local time information includes one of current time in seconds, minutes and hours at the BLE device.

18. A Bluetooth Low Energy (BLE) reception device, comprising:
a BLE receiver, configured to receive remote time information of a BLE transmission device; and
a controller, configured to configure local time of the BLE reception device according to the remote time information of a BLE transmission device.

19. The BLE reception device of claim 18, wherein:
the BLE receiver is configured to receive a broadcast period; and
the controller is configured to configure the BLE receiver according to the broadcast period to receive the remote time information of the BLE transmission device.

20. The BLE reception device of claim 18, wherein the BLE receiver is configured to receive the remote time information in an advertising Packet Data Unit (PDU) via an advertisement communication channel.

21. The BLE reception device of claim 18, wherein the remote time information includes one of current time in seconds, minutes and hours at the BLE device.

22. The BLE reception device of claim 18, wherein the controller is configured to determine whether a trigger condition is met based on the local time of the BLE reception device, and when the trigger condition is met, perform a trigger operation.
